(19) United States
(12) Patent Application Publication
(10) Pub. No.: US 2024/0172294 A1
(43) Pub. Date: May 23, 2024

(54) CONFIGURABILITY OF SLICE BASED RANDOM ACCESS CHANNELS (RACH)

(71) Applicant: Telefonaktiebolaget LM Ericsson (publ), Stockholm (SE)

(72) Inventors: Min WANG, Luleå (SE); Ylva TIMNER, Luleå (SE); Jan CHRISTOFFERSSON, Luleå (SE); Tomas FRANKKILA, Luleå (SE)

(21) Appl. No.: 18/547,634

(22) PCT Filed: Mar. 1, 2022
(86) PCT No.: PCT/IB2022/051809

§ 371 Date: Aug. 23, 2023

Related U.S. Application Data
(60) Provisional application No. 63/155,088, filed on Mar. 1, 2021.

(51) Int. Cl. H04W 74/0833

(52) U.S. Cl. CPC H04W 74/0833

(57) ABSTRACT

A method, system and apparatus for configurability of slice based random access channels (RACH) are disclosed. According to one aspect, a method in a network node includes providing RACH configuration parameters for each of a plurality slices or groups of slices, the RACH configuration parameters being used to perform a random access (RA) procedure on a slice, and performing an RA procedure on a slice according to the RACH configuration parameters for the slice.

### FIELD

The present disclosure relates to wireless communications, and in particular, to configurability of slice based random access channels (RACH).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

An example of a current 5G radio access network (RAN) architecture is described in 3GPP Technical Standard (TS) 38.401 and is depicted in FIG. 1.

The NG architecture can be further described as follows:
The NG-RAN consists of a set of network nodes such as LTE base stations (eNBs) and New Radio base stations (gNBs), hereinafter referred to as network nodes, connected to the 5G core (5GC) through an NG interface;
An eNB/gNB can support frequency division duplex (FDD) operation, time division duplex (TDD) operation or dual mode operation;
eNB/gNBs can be interconnected through the Xn interface;
A gNB may consist of a gNB centralized unit (CU) and one or more gNB distributed units (DUs);
A gNB-CU and a gNB-DU are connected via an F1 logical interface; and
One gNB-DU is connected to only one gNB-CU.

NG, Xn and F1 are logical interfaces. For NG-RAN, the NG and Xn-C interfaces for a gNB consisting of a gNB-CU and gNB-DUs, terminate in the gNB-CU. The gNB-CU and connected gNB-DUs are only visible to other gNBs and the 5GC as a gNB.

The NG-RAN is layered. There is a Radio Network Layer (RNL) and a Transport Network Layer (TNL). The NG-RAN architecture, which includes the NG-RAN logical nodes and the interfaces between them, is defined as part of the RNL. For each NG-RAN interface (NG, Xn, F1) the related TNL protocol and the functionality are specified. The TNL provides services for user plane transport and signaling transport.

Network Slicing in 3GPP Technical Release 15 (3GPP Rel-15)

Network slicing involves creating logically separated partitions of the network, each partition addressing different business purposes. These “network slices” are logically separated to a degree that they can be regarded and managed as networks of their own.

This concept potentially applies to both LTE and new NR radio access technologies (RATs). A key driver for introducing network slicing is business expansion, i.e., improving the cellular operator's ability to serve other industries, e.g., by offering connectivity services with different network characteristics (performance, security, robustness, and complexity).

The current working assumption is that there will be one shared Radio Access Network (RAN) infrastructure that will connect to several core network (CN) instances (with one or more Common Control Network Functions (CCNF), interfacing the radio access network (RAN), plus additional CN functions which may be slice-specific). As the CN functions are being virtualized, it is assumed that the operator shall instantiate a new CN, or part of it, when a new slice should be supported. This architecture is shown in FIG. 2. Slice 0 can for example be a Mobile Broadband slice and Slice 1 can for example be a Machine Type Communication network slice.

Network Slicing in 3GPP Rel 17, Considerations related to Random Access

For 3GPP NR Release 17, a study is ongoing to investigate enhancements to network slicing. One of the objectives is to study enhancements to the random access channel (RACH) to enable fast access to a slice. Two solutions have been identified:
Solution 1 (RACH isolation): a slice-specific separate RACH resource pool can be configured per slice or per slice group, in addition to the existing common RACH resources; and
Solution 2 (RACH prioritization): slice-specific RACH parameters prioritization can be configured per slice or per slice group.

In 3GPP RAN2 #113-e, RAN2 has considered and identified open issues regarding slice based RACH configuration:
Separated PRACH configuration (e.g., transmission occasions of time-frequency domain and preambles) can be configured for slice or slice group;
Existing RACH parameters prioritization (i.e., scalingFactorBI and powerRampingStepHighPriority) can be supported as baseline for slices;
Slice group is supported. Whether to define a new grouping mechanism or reuse a unified access control (UAC) access category is left to a work item (WI) phase;
The following open issues are captured in a technical release (TR):
   a) For slice specific RACH, how to perform RACH type selection (e.g., 2-step & 4-step);
   b) The fallback mechanism, e.g., whether to support 2 step slice-based RACH fallback to 4-step slice-based/common RACH;
   c) The collision in case that slice-specific random access RA prioritization is configured together with legacy RA prioritization (e.g., multimedia priority service (MPS) & modulation and coding scheme (MCS) wireless devices (WDs));
Solution 1 (RACH isolation) & solution 2 (RACH prioritization) can work independently in a complementary way.
Both solution 1 and solution 2 for slice-based RACH configuration are considered for normative work.

4-Step Random Access Procedure

A 4-step approach is used in 3GPP NR Release 15 for the Random Access (RA) procedure. Referring to FIG. 3, the WD detects Synchronization Signals (SS) and decodes the broadcasted system information, followed by transmitting a PRACH preamble (message 1) in the uplink. The gNB replies with a RAR (Random Access Response, message 2) which uses the RA-radio network temporary identifier (RNTI) and preamble ID for identification. The WD then transmits a WD identification (message 3) on the physical uplink shared channel (PUSCH) using an uplink grant (i.e., an allocation of uplink transmission resources).

The WD transmits message 3 (on the PUSCH) after receiving a timing advance command in the RAR, allowing the PUSCH to be received with a timing accuracy within the Cyclic Prefix (CP). Without this timing advance, a very large CP would be needed in order to be able to demodulate and detect the PUSCH, unless the system is applied in a cell with only a very small distance between WD and eNB. Since NR will also support larger cells with a need for providing a timing advance to the WD, the 4-step approach is needed for a random access procedure.

In 3GPP NR Release 15 (3GPP Rel-15), the WD will indicate a synchronization signal block (SSB). The purpose of this is to let the gNB know which direction (i.e., which downlink (DL) beam to use) to transmit the RAR and subsequent messages. The SSB selection by the WD is done by comparing the synchronization signal reference signal received power (SS-RSRP) to the rsrp-ThresholdSSB.

Once the SSB has been selected, the indication from the WD to the gNB is done by selection of a preamble and/or a PRACH occasion (RO), depending on the configuration. With the use of specific preambles and/or RO, the WD implicitly indicates the selected SSB to the gNB.

2-Step Random Access Procedure

The 2-step RA procedure was standardized in 3GPP NR Release 16. With the 2-step procedure the random access is completed in only two steps as illustrated in FIG. 4:
Step 1: The WD sends a message A (msgA) including a random access preamble together with higher layer data such as a radio resource control (RRC) connection request possibly with some small payload on the PUSCH (denoted “msgA PUSCH”). The msgA PUSCH is used for small data transmissions in an inactive state or mode;
Step 2: The gNB sends a response called message B (msgB) (which may be described as a modified RAR) including a WD identifier assignment, timing advance information, and a contention resolution message, etc. In addition, message B may contain a higher layer part. Similar to an RAR, an msgB may contain responses to multiple msgAs, and thus to multiple WDs, but the optional higher layer part can only pertain to one of the responses (i.e., to one of the msgAs/WDs). If a response in a msgB does not have an associated higher layer part, this will be sent in a separate subsequent message, e.g., an RRC message, on the physical downlink shared channel (PDSCH). MsgB is identified by an MsgB-RNTI.

The msgA contains a preamble transmission and a PUSCH transmission where the preamble is mapped to the PUSCH. This means that when a particular preamble is selected, the preamble implies which time and frequency and demodulation reference signal (DMRS) sequence that is used for the PUSCH transmission

The msgB is a response to msgA, which may contain contention resolution message(s), fallback indication(s) to schedule Msg3 transmission, and back off indication.

The msgB is a response to msgA, which may contain responses to multiple WDs and with different kinds of information for different WDs depending on the outcome of the msgA transmission/reception (and the load on the access resources).

Upon a successful msgA reception, the gNB includes a successRAR medium access control (MAC) subPDU as a response for the concerned WD, where the successRAR MAC subPDU includes a contention resolution identity, a timing advance and a C-RNTI allocation.

If the gNB successfully received the RACH preamble, but failed to receive the msgA PUSCH, the gNB can respond to the concerned WD with a fallbackRAR MAC subPDU in the msgB. The fallbackRAR essentially turns the 2-step RA into a 4-step RA and consequently the fallbackRAR MAC subPDU contains an UL grant, a timing advance and a temporary C-RNTI (TC-RNTI) allocation, but no contention resolution identity. The WD uses the UL grant to retransmit msgA PUSCH in the form of Msg3.

In addition to successRAR and fallbackRAR MAC subPDUs, the gNB may include a parameter which is intended for the WDs that did not find any response to their respective msgA transmissions in msgB. This parameter is the Backoff Indicator (a single parameter for all WDs which did not find their expected response in the msgB), which controls whether and how much a WD must wait until it can attempt to access the network through random access again.

At RAN2 #113-e, RAN2 has considered the following regarding slice a based RACH configuration:
1. Separated PRACH configuration (e.g., transmission occasions of time-frequency domain and preambles) can be configured for slice or slice group;
2. Existing RACH parameters prioritization (i.e., scalingFactorBI and powerRampingStepHighPriority) can be supported as baseline for slices;
3. Slice group is supported. Whether to define a new grouping mechanism or reusing UAC access category is left to WI phase;
4. Solution 1 (RACH isolation) & 2 (RACH prioritization) can work independently in a complementary way; and
5. Both solution 1 and solution 2 for slice-based RACH configuration are recommended for normative work.

From the above considerations, it is observed that the RACH prioritization feature (i.e., based on scalingFactorBI and powerRampingStepHighPriority) which was designed in NR Rel-15 will be extended to prioritized slice-based RACH accesses, i.e., referred to as Solution 2.

However, from a configurability (i.e., via RRC signaling) perspective, the existing RACH prioritization feature is only applicable to contention free random access (CFRA) based RACH procedures triggered for beam failure recovery (BFR) or handover. In addition, the feature is not applicable to contention-based random access (CBRA) based RACH procedures.

### SUMMARY

Some embodiments advantageously provide methods, network nodes, and wireless devices for configurability of slice based random access channels (RACH).

A signaling framework for applying the RACH prioritization feature for RACH procedures on specific slices or slice groups is described.

An objective of slice-based RACH is to provide a way for a WD to prioritize RACH procedures initiated for specific slices regardless of the access modes of the RACH procedures (i.e., CBRA based or CFRA based) and of the purposes of the RACH procedures. Therefore, some embodiments define ways to improve the existing signaling framework of the RACH prioritization feature (i.e., via RRC signaling) to achieve configurability for slice-based RACH.

With the signaling framework of some embodiments disclosed herein, a WD can be configured with one of the following options:
Whether RACH procedures on specific slices or slice groups can be prioritized;
Whether RACH procedures triggered by specific purposes on specific slices or slice groups can be prioritized;
Whether RACH procedures with specific RA types (i.e., 4-step RA or 2-step RA) on specific slices or slice groups can be prioritized;
Whether RACH procedures with specific Access IDs, Access classes or Access categories on specific slices or slice groups can be prioritized;
Whether Contention based RACH procedures on specific slices or slice groups can be prioritized; and
Whether Contention Free based RACH procedures on specific slices or slice groups can be prioritized.

With the proposed signaling framework, a WD can be configured with RACH prioritization for slice-based RA procedures with minimum specification changes.

According to one aspect, method in a network node 16 for configurability of slice based random access channels (RACH) is provided. The method includes providing random access channel, RACH, configuration parameters for each of a plurality of wireless communication network slice groups, each wireless communication network slice group having at least one wireless communication network slice, the RACH configuration parameters being used to perform a random access, RA, procedure on a wireless communication network slice group. The process also includes receiving a physical random access channel, PRACH, message on a wireless communication network slice according to the RACH configuration parameters for a wireless communication network slice group to which the wireless communication network slice belongs.

According to this aspect, in some embodiments, the RACH configuration parameters include at least one of the following: an indication of a priority of an RA procedure on a wireless communication network slice of a first wireless communication network slice group relative to a priority of an RA procedure on a wireless communication network slice of a second wireless communication network slice group, an indication of a purpose or event associated with a prioritized RA procedure on a wireless communication network slice group; an indication of access identity, category or class associated with a prioritized RA procedure on a wireless communication network slice group; and an indication of a carrier or cell on which an RA procedure is prioritized. In some embodiments, cell specific RACH configuration parameters are included in multiple radio resource control, RRC, information elements, IEs. In some embodiments, RACH configuration parameters for wireless communication network slice-based RACH procedures are applicable to 4-step RA procedures and 2-step RA procedures. In some embodiments, first RACH configuration parameters for wireless communication network slice-based RACH procedures are defined for contention based random access (CBRA) procedures and second RACH configuration parameters for wireless communication network slice-based RACH procedures are defined for contention free random access (CFRA) procedures.

According to another aspect, a method in a wireless device includes determining random access channel, RACH, configuration parameters for each of at least one wireless communication network slice, the RACH configuration parameters being used to configure a random access, RA, procedure for the at least one wireless communication network slice. The method also includes performing an RA procedure on a wireless communication network slice of the at least one wireless communication network slice according to a priority indicated by the RACH configuration parameters for the wireless communication network slice.

According to this aspect, in some embodiments, the RACH configuration parameters are obtained from the network node in a wireless communication network slice-specific radio resource control, RRC, information element, IE. In some embodiments, performing the RA procedure on the wireless communication network slice includes performing one of a two-step RA procedure and a four step RA procedure according to an indication included in the RACH configuration parameters. In some embodiments, performing the RA procedure on the wireless communication network slice includes performing one of a slice-based RACH procedure defined for contention based random access, CBRA, and a second wireless communication network slice-based RACH procedure defined for contention free random access. In some embodiments, the method also includes indicating whether the WD supports RA prioritization for specific wireless communication network slices.

According to yet another aspect, a network node configured to communicate with a wireless device, WD, include: processing circuitry configured to provide random access channel, RACH, configuration parameters for each of a plurality wireless communication network slice groups, each wireless communication network slice group having at least one wireless communication network slice, the RACH configuration parameters being used to perform a random access, RA, procedure on a wireless communication network slice group. The network node also includes a radio interface in communication with the processing circuitry and configured to receive a physical random access channel, PRACH, message on a wireless communication network slice according to the RACH configuration parameters for a wireless communication network slice group to which the wireless communication network slice belongs.

According to this aspect, in some embodiments, the RACH configuration parameters include at least one of the following: an indication of a priority of an RA procedure on a wireless communication network slice of a first wireless communication network slice group relative to a priority of an RA procedure on a wireless communication network slice of a second wireless communication network slice group; an indication of a purpose or event associated with a prioritized RA procedure on a wireless communication network slice group; an indication of access identity, category or class associated with a prioritized RA procedure on a wireless communication network slice group; and an indication of a carrier or cell on which an RA procedure is prioritized. In some embodiments, cell specific RACH configuration parameters are included in multiple radio resource control, RRC, information elements, IEs. In some embodiments, RACH configuration parameters for wireless communication network slice-based RACH procedures are applicable to 4-step RA procedures and 2-step RA procedures. In some embodiments, first RACH configuration parameters for wireless communication network slice-based RACH procedures are defined for contention based random access (CBRA) procedures and second RACH configuration parameters for wireless communication network slice-based RACH procedures are defined for contention free random access (CFRA) procedures.

In some embodiments, a wireless device, WD, configured to communicate with a network node is the provided. The WD includes processing circuitry configured to: determine random access channel, RACH, configuration parameters for each of at least one wireless communication network slice, the RACH configuration parameters being used to configure a random access, RA, procedure for the at least one wireless communication network slice. The processing circuitry is further configured to perform an RA procedure on a wireless communication network slice of the at least one wireless communication network slice according to a priority indicated by the RACH configuration parameters for the wireless communication network slice.

According to this aspect, in some embodiments, the RACH configuration parameters are obtained from the network node in a wireless communication network slice-specific radio resource control, RRC, information element, IE. In some embodiments, performing the RA procedure on the wireless communication network slice includes performing one of a two-step RA procedure and a four step RA procedure according to an indication included in the RACH configuration parameters. In some embodiments, performing the RA procedure on the wireless communication network slice includes performing one of a slice-based RACH procedure defined for contention based random access, CBRA, and a second wireless communication network slice-based RACH procedure defined for contention free random access. In some embodiments, the processing circuitry is further configured to indicate whether the WD supports RA prioritization for specific wireless communication network slices.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a 5G architecture;

FIG. 2 is a diagram of an architecture partitioning a network into slices;

FIG. 3 is a diagram of a 4 step random access procedure;

FIG. 4 is a diagram of a 2 step random access procedure;

FIG. 5 is a schematic diagram of an example network architecture illustrating a communication system connected via an intermediate network to a host computer according to the principles in the present disclosure;

FIG. 6 is a block diagram of a host computer communicating via a network node with a wireless device over an at least partially wireless connection according to some embodiments of the present disclosure;

FIG. 7 is a flowchart illustrating example methods implemented in a communication system including a host computer, a network node and a wireless device for executing a client application at a wireless device according to some embodiments of the present disclosure;

FIG. 8 is a flowchart illustrating example methods implemented in a communication system including a host computer, a network node and a wireless device for receiving user data at a wireless device according to some embodiments of the present disclosure;

FIG. 9 is a flowchart illustrating example methods implemented in a communication system including a host computer, a network node and a wireless device for receiving user data from the wireless device at a host computer according to some embodiments of the present disclosure;

FIG. 10 is a flowchart illustrating example methods implemented in a communication system including a host computer, a network node and a wireless device for receiving user data at a host computer according to some embodiments of the present disclosure;

FIG. 11 is a flowchart of an example process in a network node for configurability of slice based random access channels (RACH);

FIG. 12 is a flowchart of an example process in a wireless device for configurability of slice based random access channels (RACH);

FIG. 13 is a flowchart of another example process in a network node for configurability of slice based random access channels (RACH); and

FIG. 14 is a flowchart of another example process in a wireless device for configurability of slice based random access channels (RACH).

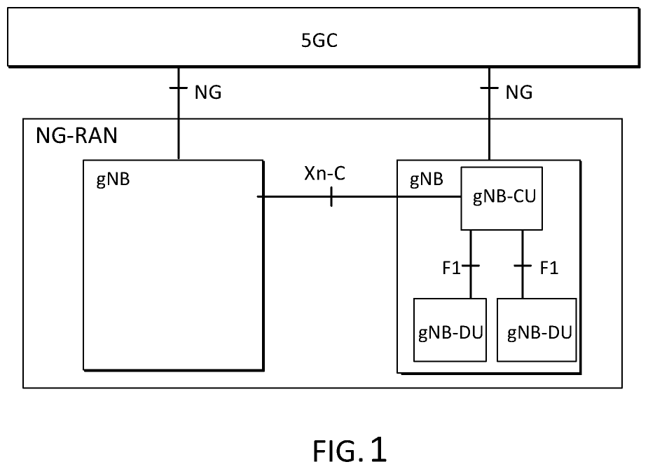

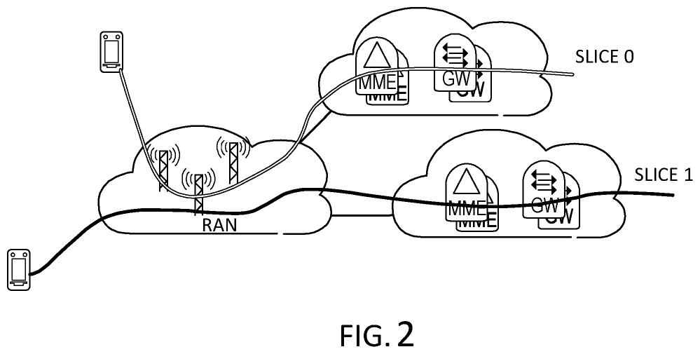

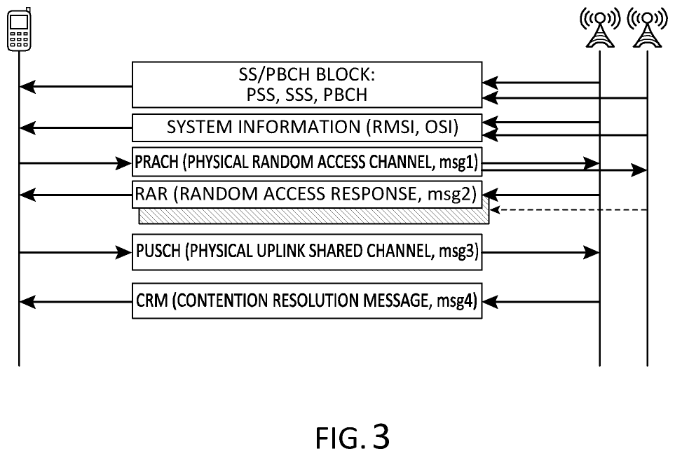

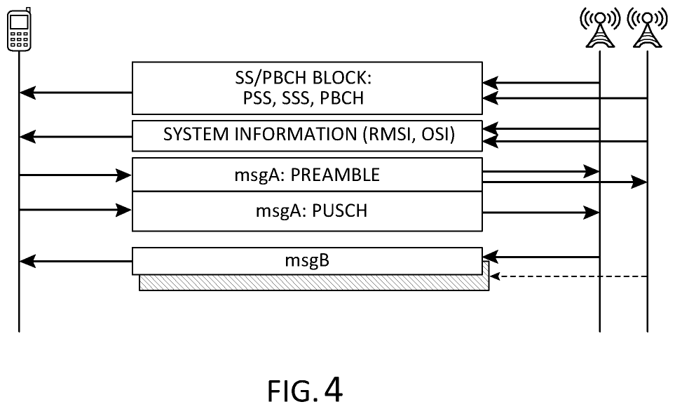

### DETAILED DESCRIPTION

Before describing in detail example embodiments, it is noted that the embodiments reside primarily in combinations of apparatus components and processing steps related to configurability of slice based random access channels (RACH). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled.” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD. Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

As used herein, the term “prioritized RA procedure” refers to an RA procedure that is to be served by a radio base station (network node, gNB, etc.) with a higher priority than another RA procedure. The term “non-prioritized RA procedure” refers to an RA procedure that is not prioritized, and consequently, is lower in priority than a prioritized RA procedure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurability of slice based random access channels (RACH).

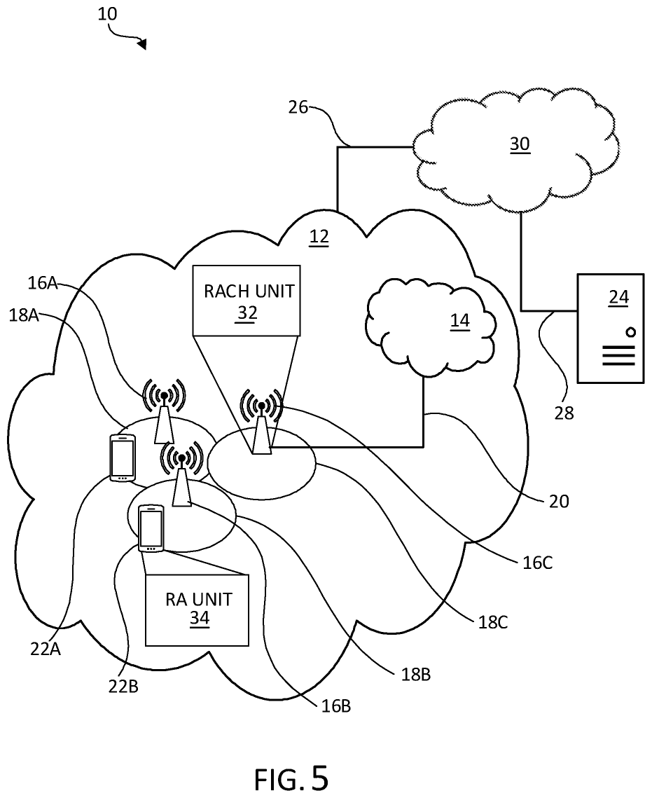

Referring again to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 5 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a RACH unit 32 which is configured to provide random access channel (RACH) configuration parameters for each of a plurality of wireless communication network slice groups, each wireless communication network slice group having at least one wireless communication network slice, the RACH configuration parameters being used to perform a random access, RA, procedure on a wireless communication network slice group. A wireless device 22 is configured to include an RA unit 34 which is configured to perform an RA procedure on a wireless communication network slice of the at least one wireless communication network slice according to a priority indicated by the RACH configuration parameters for the wireless communication network slice.

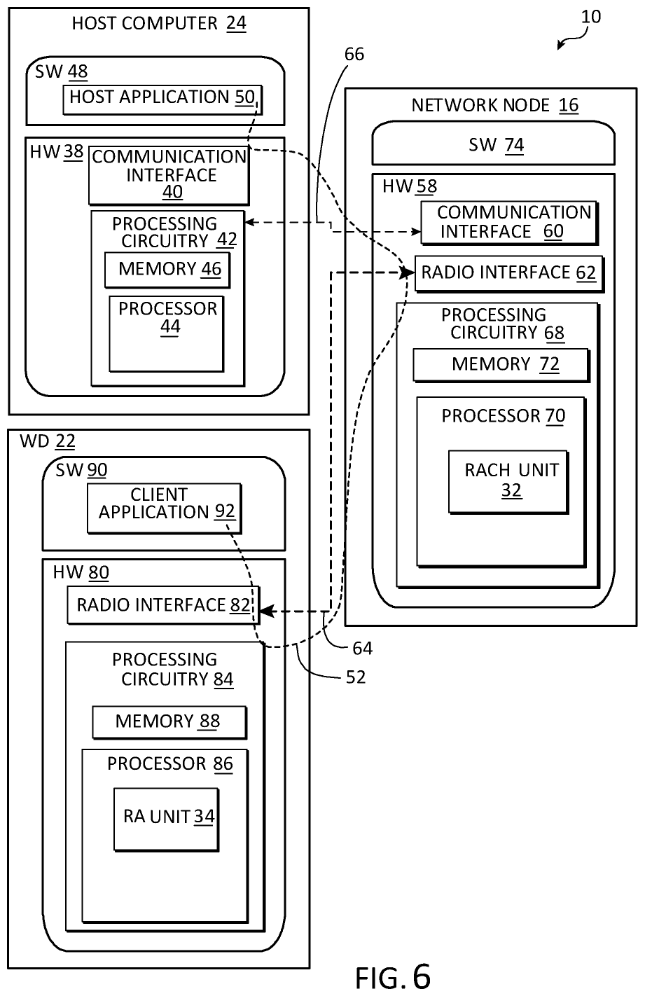

Example implementations, in accordance with an embodiment, of the WD 22, network node 16 and host computer 24 discussed in the preceding paragraphs will now be described with reference to FIG. 6. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include RACH unit 32 configured to provide random access channel (RACH) configuration parameters for each of a plurality of wireless communication network slice groups, each wireless communication network slice group having at least one wireless communication network slice, the RACH configuration parameters being used to perform a random access, RA, procedure on a wireless communication network slice group.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an RA unit 34 configured perform an RA procedure on a wireless communication network slice of the at least one wireless communication network slice according to a priority indicated by the RACH configuration parameters for the wireless communication network slice.

In some embodiments, the inner workings of the network node 16, WD 22, and host computer 24 may be as shown in FIG. 6 and independently, the surrounding network topology may be that of FIG. 5.

In FIG. 6, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 5 and 6 show various “units” such as RACH unit 32, and RA unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

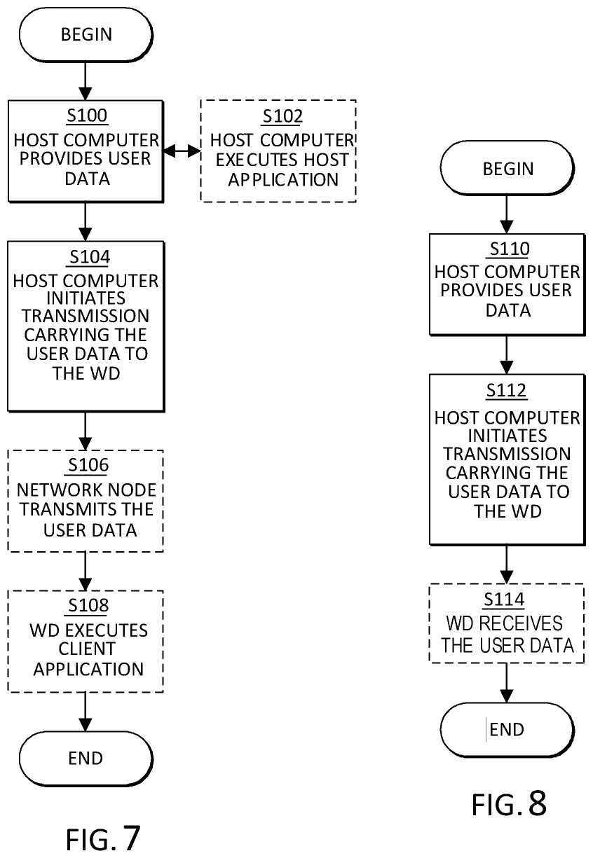

FIG. 7 is a flowchart illustrating an example method implemented in a communication system, such as, for example, the communication system of FIGS. 5 and 6, in accordance with one embodiment. The communication system may include a host computer 24, a network node 16 and a WD 22, which may be those described with reference to FIG. 6. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 8 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

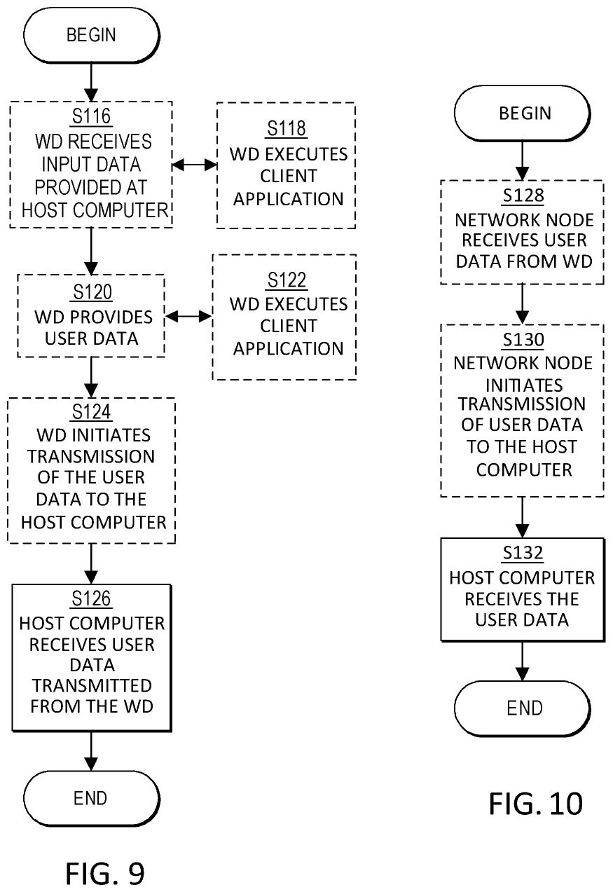

FIG. 9 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 10 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

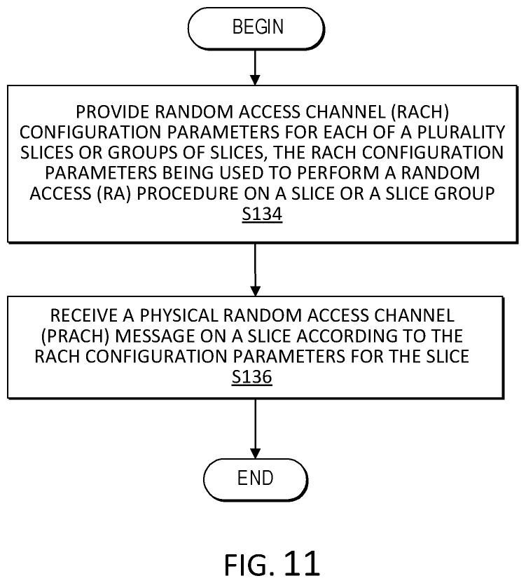

FIG. 11 is a flowchart of an example process in a network node 16 for configurability of slice based random access channels (RACH). One or more blocks described herein may be performed by one or more elements of network node 16 such as by one or more of processing circuitry 68 (including the RACH unit 32), processor 70, radio interface 62 and/or communication interface 60. Network node 16 such as via processing circuitry 68 and/or processor 70 and/or radio interface 62 and/or communication interface 60 is configured to provide random access channel, RACH, configuration parameters for each of a plurality slices or groups of slices, the RACH configuration parameters being used to perform a random access, RA, procedure on a slice (Block S134). The process further includes performing an RA procedure on a slice according to the RACH configuration parameters for the slice (Block S136).

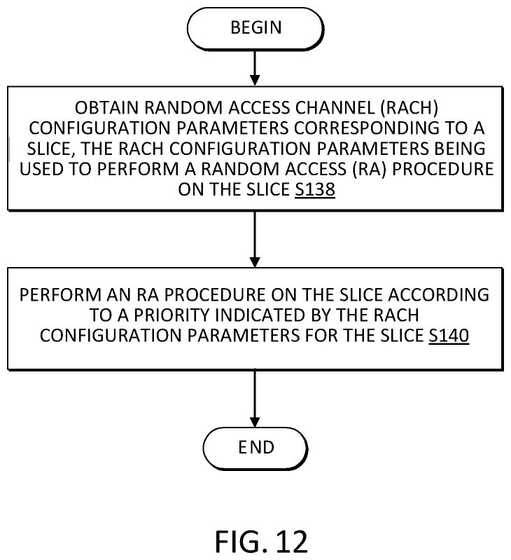

FIG. 12 is a flowchart of an example process in a wireless device 22 according to some embodiments of the present disclosure. One or more blocks described herein may be performed by one or more elements of wireless device 22 such as by one or more of processing circuitry 84 (including the RA unit 34), processor 86, radio interface 82 and/or communication interface 60. Wireless device 22 such as via processing circuitry 84 and/or processor 86 and/or radio interface 82 is configured to obtain random access channel, RACH, configuration parameters corresponding to a slice, the RACH configuration parameters being used to perform a random access, RA, procedure on the slice (Block S138). The process further includes performing an RA procedure on the slice according to the RACH configuration parameters for the slice (Block S140).

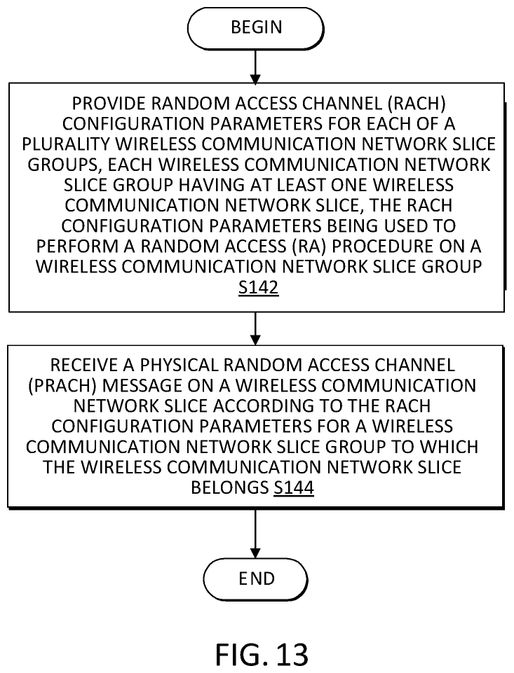

FIG. 13 is a flowchart of an example process in a network node 16 for configurability of slice based random access channels (RACH). One or more blocks described herein may be performed by one or more elements of network node 16 such as by one or more of processing circuitry 68 (including the RACH unit 32), processor 70, radio interface 62 and/or communication interface 60. Network node 16 such as via processing circuitry 68 and/or processor 70 and/or radio interface 62 and/or communication interface 60 is configured to provide random access channel, RACH, configuration parameters for each of a plurality of wireless communication network slice groups, each wireless communication network slice group having at least one wireless communication network slice, the RACH configuration parameters being used to perform a random access, RA, procedure on a wireless communication network slice group (Block S142). The process also includes receiving a physical random access channel, PRACH, message on a wireless communication network slice according to the RACH configuration parameters for a wireless communication network slice group to which the wireless communication network slice belongs (Block S144).

In some embodiments, the RACH configuration parameters include at least one of the following: an indication of a priority of an RA procedure on a wireless communication network slice of a first wireless communication network slice group relative to a priority of an RA procedure on a wireless communication network slice of a second wireless communication network slice group, an indication of a purpose or event associated with a prioritized RA procedure on a wireless communication network slice group; an indication of access identity, category or class associated with a prioritized RA procedure on a wireless communication network slice group; and an indication of a carrier or cell on which an RA procedure is prioritized. In some embodiments, cell specific RACH configuration parameters are included in multiple radio resource control, RRC, information elements, IEs. In some embodiments, RACH configuration parameters for wireless communication network slice-based RACH procedures are applicable to 4-step RA procedures and 2-step RA procedures. In some embodiments, first RACH configuration parameters for wireless communication network slice-based RACH procedures are defined for contention based random access (CBRA) procedures and second RACH configuration parameters for wireless communication network slice-based RACH procedures are defined for contention free random access (CFRA) procedures.

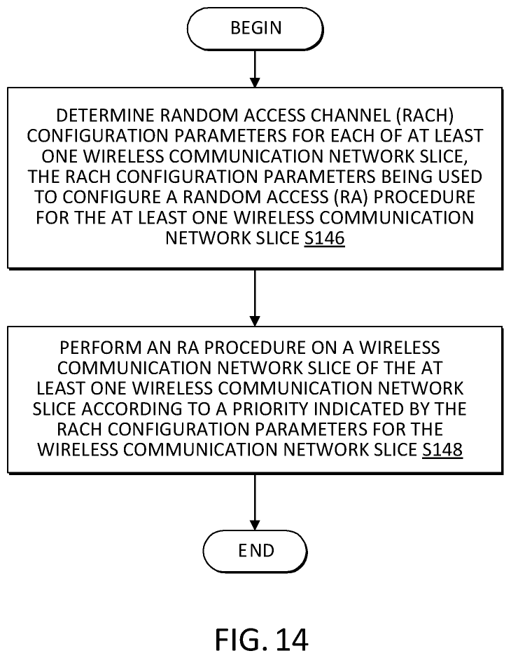

FIG. 14 is a flowchart of an example process in a wireless device 22 according to some embodiments of the present disclosure. One or more blocks described herein may be performed by one or more elements of wireless device 22 such as by one or more of processing circuitry 84 (including the RA unit 34), processor 86, radio interface 82 and/or communication interface 60. Wireless device 22 such as via processing circuitry 84 and/or processor 86 and/or radio interface 82 is configured to determine random access channel, RACH, configuration parameters for each of at least one wireless communication network slice, the RACH configuration parameters being used to configure a random access, RA, procedure for the at least one wireless communication network slice (Block S146). The process also includes performing an RA procedure on a wireless communication network slice of the at least one wireless communication network slice according to a priority indicated by the RACH configuration parameters for the wireless communication network slice (Block S148).

In some embodiments, the RACH configuration parameters are obtained from the network node in a wireless communication network slice-specific radio resource control, RRC, information element, IE. In some embodiments, performing the RA procedure on the wireless communication network slice includes performing one of a two-step RA procedure and a four step RA procedure according to an indication included in the RACH configuration parameters. In some embodiments, performing the RA procedure on the wireless communication network slice includes performing one of a slice-based RACH procedure defined for contention based random access, CBRA, and a second wireless communication network slice-based RACH procedure defined for contention free random access. In some embodiments, the method also includes indicating whether the WD supports RA prioritization for specific wireless communication network slices.

Having described the general process flow of arrangements of the disclosure and having provided examples of hardware and software arrangements for implementing the processes and functions of the disclosure, the sections below provide details and examples of arrangements for configurability of slice based random access channels (RACH).

The embodiments described below refer to an NR RAT and associated network elements, but can also be applied to an LTE RAT and any other RATs and associated network elements supporting slice-based RACH. In addition, the methods and solutions are applicable to both 4-step RACH and 2-step RACH procedures. Furthermore, the methods, arrangements and solutions disclosed in the following for slice-based RACH can also be applied to slice-group-based RACH, where RACH is configured for a group of slices.

Also, in the embodiments disclosed herein, the WD 22 may initiate an RA procedure. This could be a two-step or four step RA procedure as discussed above. A WD 22 can be configured with multiple slices that may be prioritized. In some embodiments, RA procedures on a slice may be prioritized over RA procedures on other slices. In some embodiments, an RA procedure associated with one purpose on a slice may be prioritized over RA procedures associated with another purpose on the slice.

In a first embodiment, configuration parameters for slice-based RACH procedures are added into the cell-specific RA configurations. These configuration parameters may be provided to indicate to WDs 22 at least one of the following:
slices or slice groups on which RA procedures can be prioritized over other RA procedures (e.g., which are initiated on the other slices);
events, or purposes of the prioritized RA procedures initiated on specific slices (e.g., which are prioritized over other slices); and/or
Access Identities or Access Categories or Access classes which are associated with the prioritized RA procedures on specific slices (e.g., which are prioritized over other slices).

Cell specific RA configurations may be signaled by the network node 16 via system information (SI) or dedicated radio resource control (RRC) signaling.

The configuration parameters may include at least one of the following:
parameters indicating identifiers of slices or slice groups on which RA procedures are prioritized over RA procedures on other slices:
   A bitmap field may be defined for indicating identifiers of these slices or slice groups. The bitmap contains multiple bits wherein each bit corresponds to a specific slice or slice group. Alternatively, parameters indicating these slice/slice group indices are defined;
Parameters indicating purposes/events which are associated with the prioritized RA procedures on specific slices (e.g., that are prioritized over other slices);
These purposes/events may include at least one of the following:
   Initial access from RRC_IDLE;
   RRC Connection Re-establishment procedure;
   DL or UL data arrival during RRC_CONNECTED when UL synchronization status is “non-synchronized”;
   UL data arrival during RRC_CONNECTED when there are no PUCCH resources for scheduling request (SR) available;
   SR failure;
   Request by RRC upon synchronous reconfiguration (e.g., handover);
   Transition from RRC_INACTIVE;
   To establish time alignment for a secondary timing advance group (TAG);
   Request for Other system information (SI);
   Beam failure recovery; and/or
   Consistent uplink (UL) listen before talk (LBT) failure on SpCell;
A bitmap field may be defined for indicating the above events. In this case, each event may be associated with a unique event index. The bitmap may contain multiple bits, where each bit corresponds to a specific event. Alternatively, parameters indicating the above event types or event indices may be defined;
As an alternative, all purposes/events may implicitly use prioritized RA on the specific slices;
As an alternative, the purposes/events that may use prioritized RA on the specific slices may be specified in a standard specification;
Parameters indicating Access Identities or Access Categories or Access classes which are associated with the prioritized RA procedures on specific slices or slice groups (e.g., that are prioritized over other slices or slice groups):
   A bitmap field may be defined for indicating these Access Identities or Access Categories or Access classes. The bitmap contains multiple bits wherein each bit corresponds to a specific Access Identities or Access Categories or Access classes. Alternatively, parameters indicating these Access Identities identifiers of Access Categories or Access classes are defined;
Parameters apply for prioritized RA procedures on specific slices or slice groups (e.g., that are prioritized over other slices or slice groups), which may include at least one of the following (for example, as specified in clause 5.1.1 of 3GPP Technical Standard (TS) 38.321 v16.3.0), i.e.:
   prach-ConfigurationIndex;
   prach-ConfigurationPeriodScaling-IAB;
   prach-ConfigurationFrameOffset-IAB;
   prach-ConfigurationSOffset-IAB;
   msgA-PRACH-ConfigurationIndex;
   preambleReceivedTargetPower;
   msgA-PreambleReceivedTargetPower;
   rsrp-ThresholdSSB;
   rsrp-ThresholdCSI-RS;
   msgA-RSRP-ThresholdSSB;
   rsrp-ThresholdSSB-SUL;
   msgA-RSRP-Threshold;
   msgA-TransMax;
   candidateBeamRSList;
   recoverySearchSpaceId;
   powerRampingStep;
   msgA-PreamblePowerRampingStep;
   powerRampingStepHighPriority;
   scalingFactorBI;
   ra-PreambleIndex;
   ra-ssb-OccasionMaskIndex;
   msgA-SSB-SharedRO-MaskIndex;
   ra-OccasionList;
   ra-PreambleStartIndex;
   preamble TransMax;
   ssb-perRACH-OccasionAndCB-PreamblesPerSSB;
   msgA-CB-PreamblesPerSSB-PerSharedRO;
   msgA-SSB-PerRACH-OccasionAndCB-PreamblesPerSSB;
   msgA-PUSCH-ResourceGroupA;
   msgA-PUSCH-ResourceGroupB;
   msgA-PUSCH-Resource-Index;
   ra-Msg3SizeGroupA;
   msg3-DeltaPreamble;
   messagePowerOffsetGroupB;
   numberOfRA-PreamblesGroupA.
   msgA-DeltaPreamble;
   messagePowerOffsetGroupB;
   numberOfRA-PreamblesGroupA;
   ra-MsgA-SizeGroupA;
   ra-Response Window;
   ra-ContentionResolutionTimer; and/or
   msgB-ResponseWindow.
Parameters indicating specified algorithms or protocol formats may also apply for prioritized RA procedures on specific slices may also be specified;
Parameters indicating carriers or cells on which RA procedures are prioritized:
   A bitmap field may be defined for indicating carriers or cells. The bitmap contains multiple bits wherein each bit corresponds to a specific carrier or cell. Alternatively, parameters indicating indices of carriers or cells are defined.

The cell specific configurations may be included in one or multiple RRC information elements (IEs) RACH-ConfigCommon(s), or RACH-ConfigGeneric(s) or in slice specific RRC IEs and may be included in system information (SI).

When a WD 22 receives the RA configurations, upon triggering of an RA procedure on a slice, the WD 22 may perform the steps below to handle the RA procedure:
1. Determine if the RA procedure needs to be prioritized over other RA procedures according to the received configuration parameters based at least in part on at least one of the below conditions:
   a. Whether the slice needs to be prioritized over other slices;
   b. Whether the RA procedure is associated with specific RA purpose/event which needs to be prioritized over other RA events/purposes;
   c. Whether the RA procedure is associated with specific Access Identities or Access Categories or Access classes which need to be prioritized;
   d. Whether the RA procedure is associated with a specific type (e.g., 4-step RA or 2-step RA) which needs to be prioritized (e.g., on a slice, there may be only 4-step RA or 2-step RA to be prioritized); and/or
   e. Whether the RA procedure is CBRA or CFRA (e.g., on a slice, there may be only CBRA or CFRA to be prioritized);
2. If the RA procedure is a prioritized RA as determined in 1), the WD 22 applies the received configuration parameters to achieve prioritization (e.g., applies higher transmission power or shorter back-off time) for the RA procedure.

In a second embodiment, part or full configuration parameters for slice-based RACH procedures which are described in the first embodiments are included in the dedicated random-access configurations, for example, which may include at least one of the following RRC IEs:
One or multiple IE BeamFailureRecoveryConfig(s); and/or
One or multiple IE RACH-ConfigDedicated(s).

In a third embodiment, for any one of the above embodiments, configuration parameters for slice-based RACH procedures in a cell-specific random-access configuration or in a dedicated random-access configuration is applicable to both 4-step RA procedures and 2-step RA procedures. Alternatively, different configuration parameters for slice-based RACH procedures are defined for 4-step RA procedures and 2-step RA procedures separately. In an example, on specific slices or slice groups, RA prioritization may be only applicable to 4-step RA procedures, but not to 2-step RA procedures. In another example, on specific slices or slice groups, RA prioritization may be only applicable to 2-step RA procedures, but not to 4-step RA procedures.

In a fourth embodiment, for any one of the above embodiments, different configuration parameters for slice-based RACH procedures are defined for CBRA procedures and CFRA procedures separately. In an example, on specific slices or slice groups, RA prioritization may be only applicable to CBRA procedures, but not to CFRA procedures. In another example, on specific slices or slice groups, RA prioritization may be only applicable to CFRA procedures, but not to CBRA procedures

In a fifth embodiment, WD 22 capabilities indicate, e.g., with a bit, code word or a parameter, whether the WD 22 supports RA prioritization for specific slices. There may be separate WD 22 capabilities for indicating whether the WD 22 supports prioritization for 4-step RA and/or 2-step RA on specific slices respectively.

Thus, according to one aspect, a network node 16 is configured to communicate with a wireless device, WD 22. The network node 16 includes a radio interface 62 and/or processing circuitry 68 configured to provide random access channel, RACH, configuration parameters for each of a plurality slices or groups of slices, the RACH configuration parameters being used to perform a random access, RA, procedure on a slice or a slice group. The network node 16, processing circuitry 68 and/or radio interface 62 are configured to receive a PRACH message on a slice according to the RACH configuration parameters.

According to this aspect, in some embodiments, the RACH configuration parameters include at least one of the following: an indication of a priority of an RA procedure on the slice relative to a priority of an RA procedure on another slice; an indication of a purpose or event associated with a prioritized RA procedure on the slice or the slice group; an indication of access identity, category or class associated with a prioritized RA procedure on the slice or the slice group; an indication of a carrier or cell on which an RA procedure is prioritized.

In some embodiments, cell specific RACH configuration parameters are included in multiple radio resource control, RRC, information elements, IEs. In some embodiments, RACH configuration parameters for slice-based RACH procedures are applicable to 4-step RA procedures and 2-step RA procedures. In some embodiments, first RACH configuration parameters for slice-based RACH procedures are defined for contention based random access (CBRA) procedures and second RACH configuration parameters for slice-based RACH procedures are defined for contention free random access (CFRA) procedures.

According to another aspect, a method implemented in a network node 16 includes providing random access channel, RACH, configuration parameters for each of a plurality slices or groups of slices, the RACH configuration parameters being used to perform a random access, RA, procedure on a slice or a slice group. The method also includes receiving a PRACH message on a slice according to the RACH configuration parameters.

According to this aspect, in some embodiments, the RACH configuration parameters include at least one of the following: an indication of a priority of an RA procedure on the slice relative to a priority of an RA procedure on another slice; an indication of a purpose or event associated with a prioritized RA procedure on the slice or the slice group; an indication of access identity, category or class associated with a prioritized RA procedure on the slice or the slice group; an indication of a carrier or cell on which an RA procedure is prioritized. In some embodiments, RACH configuration parameters for slice-based RACH procedures are applicable to 4-step RA procedures and 2-step RA procedures. In some embodiments, first RACH configuration parameters for slice-based RACH procedures are defined for contention based random access (CBRA) procedures and second RACH configuration parameters for slice-based RACH procedures are defined for contention free random access (CFRA) procedures.

According to yet another embodiment, a WD 22 is configured to communicate with a network node 16. The WD 22 includes a radio interface 82 and/or processing circuitry 84 configured to: obtain random access channel, RACH, configuration parameters corresponding to a slice, the RACH configuration parameters being used to perform a random access, RA, procedure on the slice; and perform an RA procedure on the slice according to a priority indicated by the RACH configuration parameters for the slice.

According to this aspect, in some embodiments, the obtaining is by receiving the RACH configuration parameters from the network node 16 in a slice-specific radio resource control, RRC, information element, IE. In some embodiments, performing the RA procedure on the slice includes performing one of a two-step RA procedure and a four step RA procedure according to an indication included in the RACH configuration parameters. In some embodiments, performing the RA procedure on the slice includes performing one of a first slice-based RACH procedure defined for contention based random access, CBRA, and a second slice-based RACH procedure defined for contention free random access. In some embodiments, the WD 22, processing circuitry and/or radio interface are further configured to transmit an indication of whether the WD 22 supports RA prioritization for specific slices and/or whether the WD 22 supports prioritization for two and/or four step RA procedures.

According to another aspect, a method implemented in a wireless device (WD) 22 includes obtaining random access channel, RACH, configuration parameters corresponding to a slice, the RACH configuration parameters being used to perform a random access, RA, procedure on the slice. The method also includes performing an RA procedure on the slice according to a priority indicated by the RACH configuration parameters for the slice.

According to this aspect, in some embodiments, the obtaining is by receiving the RACH configuration parameters from the network node 16 in a slice-specific radio resource control, RRC, information element, IE. In some embodiments, performing the RA procedure on the slice includes performing one of a two-step RA procedure and a four step RA procedure according to an indication included in the RACH configuration parameters. In some embodiments, performing the RA procedure on the slice includes performing one of a first slice-based RACH procedure defined for contention based random access, CBRA, and a second slice-based RACH procedure defined for contention free random access. In some embodiments, the method also includes transmitting an indication of whether the WD 22 supports RA prioritization for specific slices and/or whether the WD 22 supports prioritization for two and/or four step RA procedures.

Some embodiments may include one or more of the following:

Embodiment A1. A wireless device, WD, configured to communicate with a network node, the WD configured to, and/or comprising a radio interface and/or processing circuitry configured to:
obtain random access channel, RACH, configuration parameters corresponding to a slice, the RACH configuration parameters being used to perform a random access, RA, procedure on the slice; and
perform an RA procedure on the slice according to a priority indicated by the RACH configuration parameters for the slice.

Embodiment A2. The WD of Embodiment A1, wherein the obtaining is by receiving the RACH configuration parameters from the network node in a slice-specific radio resource control, RRC, information element, IE.

Embodiment A3. The WD of any of Embodiments A1 and A2, wherein performing the RA procedure on the slice includes performing one of a two-step RA procedure and a four step RA procedure according to an indication included in the RACH configuration parameters.

Embodiment A4. The WD of any of Embodiments A1-A3, wherein performing the RA procedure on the slice includes performing one of a first slice-based RACH procedure defined for contention based random access, CBRA, and a second slice-based RACH procedure defined for contention free random access.

Embodiment A5. The WD of any of Embodiments A1-A4, wherein the WD, processing circuitry and/or radio interface are further configured to transmit an indication of whether the WD supports RA prioritization for specific slices and/or whether the WD supports prioritization for two and/or four step RA procedures.

Embodiment B1. A method implemented in a wireless device (WD), the method comprising:
obtaining random access channel, RACH, configuration parameters corresponding to a slice, the RACH configuration parameters being used to perform a random access, RA, procedure on the slice; and
performing an RA procedure on the slice according to a priority indicated by the RACH configuration parameters for the slice.

Embodiment B2. The method of Embodiment B1, wherein the obtaining is by receiving the RACH configuration parameters from the network node in a slice-specific radio resource control, RRC, information element, IE.

Embodiment B3. The method of any of Embodiments B1 and B2, wherein performing the RA procedure on the slice includes performing one of a two-step RA procedure and a four step RA procedure according to an indication included in the RACH configuration parameters.

Embodiment B4. The method of any of Embodiments B1-B3, wherein performing the RA procedure on the slice includes performing one of a first slice-based RACH procedure defined for contention based random access, CBRA, and a second slice-based RACH procedure defined for contention free random access.

Embodiment B5. The method of any of Embodiments B1-B4, further comprising transmitting an indication of whether the WD supports RA prioritization for specific slices and/or whether the WD supports prioritization for two and/or four step RA procedures.

Embodiment C1. A network node configured to communicate with a wireless device, WD, the network node configured to, and/or comprising a radio interface and/or comprising processing circuitry configured to:
provide random access channel, RACH, configuration parameters for each of a plurality slices or groups of slices, the RACH configuration parameters being used to perform a random access, RA, procedure on a slice or a slice group; and
receive a physical random access channel, PRACH, message on a slice according to the RACH configuration parameters for the slice.

Embodiment C2. The network node of Embodiment C1, wherein the RACH configuration parameters include at least one of the following:
an indication of a priority of an RA procedure on the slice relative to a priority of an RA procedure on another slice;
an indication of a purpose or event associated with a prioritized RA procedure on the slice or the slice group;
an indication of access identity, category or class associated with a prioritized RA procedure on the slice or the slice group;
an indication of a carrier or cell on which an RA procedure is prioritized.

Embodiment C3. The network node of any of Embodiments C1 and C2, wherein cell specific RACH configuration parameters are included in multiple radio resource control, RRC, information elements, IEs.

Embodiment C4. The network node of any of Embodiments C1-C3, wherein RACH configuration parameters for slice-based RACH procedures are applicable to 4-step RA procedures and 2-step RA procedures.

Embodiment C5. The network node of any of Embodiments C1-C4, wherein first RACH configuration parameters for slice-based RACH procedures are defined for contention based random access (CBRA) procedures and second RACH configuration parameters for slice-based RACH procedures are defined for contention free random access (CFRA) procedures.

Embodiment D1. A method implemented in a network node, the method comprising:
providing random access channel, RACH, configuration parameters for each of a plurality slices or groups of slices, the RACH configuration parameters being used to perform a random access, RA, procedure on a slice or a slice group; and
receiving a physical random access channel, PRACH, message on a slice according to the RACH configuration parameters for the slice.

Embodiment D2. The method of Embodiment D1, wherein the RACH configuration parameters include at least one of the following:
an indication of a priority of an RA procedure on the slice relative to a priority of an RA procedure on another slice;
an indication of a purpose or event associated with a prioritized RA procedure on the slice or the slice group;
an indication of access identity, category or class associated with a prioritized RA procedure on the slice or the slice group;
an indication of a carrier or cell on which an RA procedure is prioritized.

Embodiment D3. The method of any of Embodiments D1 and D2, wherein cell specific RACH configuration parameters are included in multiple radio resource control, RRC, information elements, IEs.

Embodiment D4. The method of any of Embodiments D1-D3, wherein RACH configuration parameters for slice-based RACH procedures are applicable to 4-step RA procedures and 2-step RA procedures.

Embodiment D5. The method of any of Embodiments D1-D4, wherein first RACH configuration parameters for slice-based RACH procedures are defined for contention based random access (CBRA) procedures and second RACH configuration parameters for slice-based RACH procedures are defined for contention free random access (CFRA) procedures.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
AMF Access and Mobility Management Function
C-RNTI Cell-RNTI
CBRA Contention Based RA
CFRA Contention Free RA
CU Centralized Unit
CP Cyclic Prefix
DMRS Demodulation Reference Signal
DU Distributed Unit
NR New Radio
NW Network
PRACH Physical RACH
PDSCH Physical Downlink Shared Channel
PDU Packet Data Unit
PUSCH Physical Uplink Shared Channel
RA Random Access
RACH Random Access Channel
RAN Radio Access Network
RAR Random Access Response
RAT Radio Access Technology
RNL Radio Network Layer
RNTI Radio Network Temporary Identifier
RRC Radio Resource Control
TC-RNTI Temporary C-RNTI
TNL Transport Network Layer

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device, WD, configured to communicate with a network node, the WD comprising processing circuitry configured to:
determine random access channel, RACH, configuration parameters for each of at least one wireless communication network slice, the RACH configuration parameters being used to configure a random access, RA, procedure for the at least one wireless communication network slice; and
perform an RA procedure on a wireless communication network slice of the at least one wireless communication network slice according to a priority indicated by the RACH configuration parameters for the wireless communication network slice.

2. The WD of claim 1, wherein the RACH configuration parameters are obtained from the network node in a wireless communication network slice-specific radio resource control, RRC, information element, IE.

3. The WD of claim 1, wherein performing the RA procedure on the wireless communication network slice includes performing one of a two-step RA procedure and a four step RA procedure according to an indication included in the RACH configuration parameters.

4. The WD of claim 1, wherein performing the RA procedure on the wireless communication network slice includes performing one of a slice-based RACH procedure defined for contention based random access, CBRA, and a second wireless communication network slice-based RACH procedure defined for contention free random access.

5. The WD of claim 1, wherein the processing circuitry is further configured to indicate whether the WD supports RA prioritization for specific wireless communication network slices.

6. A method implemented in a wireless device, WD, the method comprising:
determining random access channel, RACH, configuration parameters for each of at least one wireless communication network slice, the RACH configuration parameters being used to configure a random access, RA, procedure for the at least one wireless communication network slice; and
performing an RA procedure on a wireless communication network slice of the at least one wireless communication network slice according to a priority indicated by the RACH configuration parameters for the wireless communication network slice.

7. The method of claim 6, wherein the RACH configuration parameters are obtained from the network node in a wireless communication network slice-specific radio resource control, RRC, information element, IE.

8. The method of claim 6, wherein performing the RA procedure on the wireless communication network slice includes performing one of a two-step RA procedure and a four step RA procedure according to an indication included in the RACH configuration parameters.

9. The method of claim 6, wherein performing the RA procedure on the wireless communication network slice includes performing one of a slice-based RACH procedure defined for contention based random access, CBRA, and a second wireless communication network slice-based RACH procedure defined for contention free random access.

10. The method of claim 6, further comprising indicating whether the WD supports RA prioritization for specific wireless communication network slices.

11. A network node configured to communicate with a wireless device, WD, the network node comprising:
processing circuitry configured to provide random access channel, RACH, configuration parameters for each of a plurality wireless communication network slice groups, each wireless communication network slice group having at least one wireless communication network slice, the RACH configuration parameters being used to perform a random access, RA, procedure on a wireless communication network slice group; and
a radio interface in communication with the processing circuitry and configured to receive a physical random access channel, PRACH, message on a wireless communication network slice according to the RACH configuration parameters for a wireless communication network slice group to which the wireless communication network slice belongs.

12. The network node of claim 11, wherein the RACH configuration parameters include at least one of the following:
an indication of a priority of an RA procedure on a wireless communication network slice of a first wireless communication network slice group relative to a priority of an RA procedure on a wireless communication network slice of a second wireless communication network slice group;
an indication of a purpose or event associated with a prioritized RA procedure on a wireless communication network slice group;
an indication of access identity, category or class associated with a prioritized RA procedure on a wireless communication network slice group; and
an indication of a carrier or cell on which an RA procedure is prioritized.

13. The network node of claim 11, wherein cell specific RACH configuration parameters are included in multiple radio resource control, RRC, information elements, IEs.

14. The network node of claim 11, wherein RACH configuration parameters for wireless communication network slice-based RACH procedures are applicable to 4-step RA procedures and 2-step RA procedures.

15. The network node of claim 11, wherein first RACH configuration parameters for wireless communication network slice-based RACH procedures are defined for contention based random access (CBRA) procedures and second RACH configuration parameters for wireless communication network slice-based RACH procedures are defined for contention free random access (CFRA) procedures.

16. A method implemented in a network node, the method comprising:
providing random access channel, RACH, configuration parameters for each of a plurality of wireless communication network slice groups, each wireless communication network slice group having at least one wireless communication network slice, the RACH configuration parameters being used to perform a random access, RA, procedure on a wireless communication network slice group; and
receiving a physical random access channel, PRACH, message on a wireless communication network slice according to the RACH configuration parameters for a wireless communication network slice group to which the wireless communication network slice belongs.

17. The method of claim 16, wherein the RACH configuration parameters include at least one of the following:
an indication of a priority of an RA procedure on a wireless communication network slice of a first wireless communication network slice group relative to a priority of an RA procedure on a wireless communication network slice of a second wireless communication network slice group;
an indication of a purpose or event associated with a prioritized RA procedure on a wireless communication network slice group;
an indication of access identity, category or class associated with a prioritized RA procedure on a wireless communication network slice group; and
an indication of a carrier or cell on which an RA procedure is prioritized.

18. The method of claim 16, wherein cell specific RACH configuration parameters are included in multiple radio resource control, RRC, information elements, IEs.

19. The method of claim 16, wherein RACH configuration parameters for wireless communication network slice-based RACH procedures are applicable to 4-step RA procedures and 2-step RA procedures.

20. The method of claim 16, wherein first RACH configuration parameters for wireless communication network slice-based RACH procedures are defined for contention based random access (CBRA) procedures and second RACH configuration parameters for wireless communication network slice-based RACH procedures are defined for contention free random access (CFRA) procedures.
